(19) United States
(12) Patent Application Publication
(10) Pub. No.: US 2018/0170030 A1
(43) Pub. Date: Jun. 21, 2018

(54) ELECTRONIC APPARATUS AND DISASSEMBLING METHOD THEREFOR

(71) Applicant: FUJITSU LIMITED, Kawasaki-shi (JP)

(72) Inventor: Yutaka NODA, Kawasaki (JP)

(73) Assignee: FUJITSU LIMITED, Kawasaki-shi (JP)

(21) Appl. No.: 15/896,115

(22) Filed: Feb. 14, 2018

Related U.S. Application Data
(62) Division of application No. 15/422,502, filed on Feb. 2, 2017.

(30) Foreign Application Priority Data
May 10, 2016 (JP) 2016-094251

(51) Int. Cl. B32B 43/00; H04M 1/02; G06F 1/16

(52) U.S. Cl. CPC B32B 43/006; H04M 1/0266; G06F 2200/1634; G06F 2200/1631; G06F 1/1633; G06F 1/1626; B32B 2457/00

(57) ABSTRACT

An electronic apparatus, includes: a housing; a panel; a first bonding agent disposed along an edge of the housing and configured to join the housing and the panel to each other; and a joining member disposed at part of the edge of the housing and having a joining strength lower than a joining strength of the first bonding agent.

### CROSS-REFERENCE TO RELATED APPLICATION

This application is a divisional of application Ser. No. 15/422,502, filed Feb. 2, 2017, which is based upon and claims the benefit of priority of the prior Japanese Patent Application No. 2016-094251, filed on May 10, 2016, the entire contents of which are incorporated herein by reference.

### FIELD

The present embodiments relate to an electronic apparatus and a disassembling method therefor.

### BACKGROUND

A liquid crystal display panel, an organic electroluminescence (EL) display panel and so forth are used for mobile apparatus such as smartphones and tablet type terminal apparatus.

A related art is disclosed in Japanese Laid-open Patent Publication No. 2014-237074 or 2005-309179.

### SUMMARY

According to an aspect of the embodiment, an electronic apparatus, includes: a housing; a panel; a first bonding agent disposed along an edge of the housing and configured to join the housing and the panel to each other; and a joining member disposed at part of the edge of the housing and having a joining strength lower than a joining strength of the first bonding agent.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 depicts an example of a plan view of an electronic apparatus;

FIG. 2 depicts an example of a sectional view taken along line I-I of FIG. 1;

FIG. 3A depicts an example of a plan view of a display panel;

FIG. 3B depicts an example of a plan view of a housing;

FIG. 4 illustrates an example of temperature dependence of joining strength of a bonding agent and a double-sided adhesive tape;

FIG. 5 illustrates an example of a disassembling method of an electronic apparatus;

FIGS. 6A to 6C depict examples of a plan view of an electronic apparatus;

FIGS. 7A to 7C depict examples of a plan view of an electronic apparatus;

FIG. 8 depicts an example of a plan view of a different electronic apparatus; and

FIG. 9 depicts an example of a sectional view taken along line II-II of FIG. 8.

### DESCRIPTION OF EMBODIMENTS

A glass plate is used in a display panel such as a liquid crystal display panel or an organic EL display panel. For example, if it is tried to fix a housing of a mobile apparatus and a display panel using a screw, stress may be concentrated around the screw to break the display panel. If the head of the screw is exposed, designability may be damaged.

Therefore, upon assembly of a mobile apparatus such as a smartphone or a tablet, principally a double-sided adhesive tape is used. For example, the double-sided adhesive tape is pasted along an edge of a display panel such that the display panel is joined to a housing through the double-sided adhesive tape.

Together with upsizing of a display panel, the weight of the display panel increases, and a sufficient joining strength may not be secured with a double-sided adhesive tape. Therefore, a bonding agent may be used in place of a double-sided adhesive tape.

From a point of view of resource saving, a display panel or some other parts is/are recycled when an electronic apparatus is repaired or discarded. Since a double-sided adhesive tape and a bonding agent have a nature that, if heat is applied thereto, the joining strength decreases, when an electronic part is to be disassembled, heat is applied to a joining region of the electronic part.

Since a bonding agent originally has a high bonding force, the joining strength may not decrease sufficiently at such a temperature (for example, 70° C. or less) that it does not have an influence on the performance of the display panel. Therefore, where a housing and a display panel are joined together by a bonding agent, it may be difficult to disassemble the electronic apparatus without suffering from damage thereto.

In order to facilitate disassembly of an electronic apparatus, for example, when the housing and the panel are joined together with a sealing material (bonding agent), a peelable structure material is disposed between the housing and the sealing material such that it extends along a longitudinal direction of the sealing material at part of the sealing material in its widthwise direction. Therefore, since the reliability of the sealing structure is secured and the contact area between the sealing material and the housing is reduced, disassembly of the electronic apparatus may be facilitated.

However, for example, if the ease of a disassembling operation is taken into consideration, it may be difficult to secure the joining strength between the housing and the panel in ordinary use of the electronic apparatus.

For example, an electronic apparatus that secures a sufficient joining strength in ordinary use but is, upon disassembling operation, disassembled readily without damaging a housing and a panel and a disassembling method for the electronic apparatus may be provided.

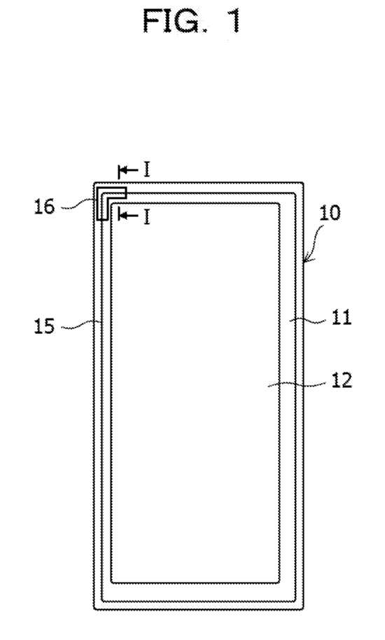

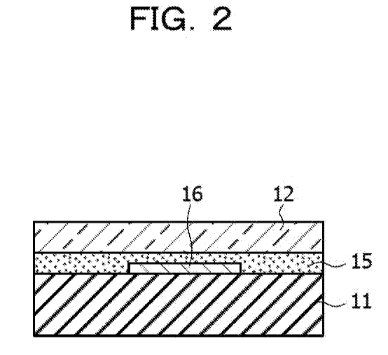

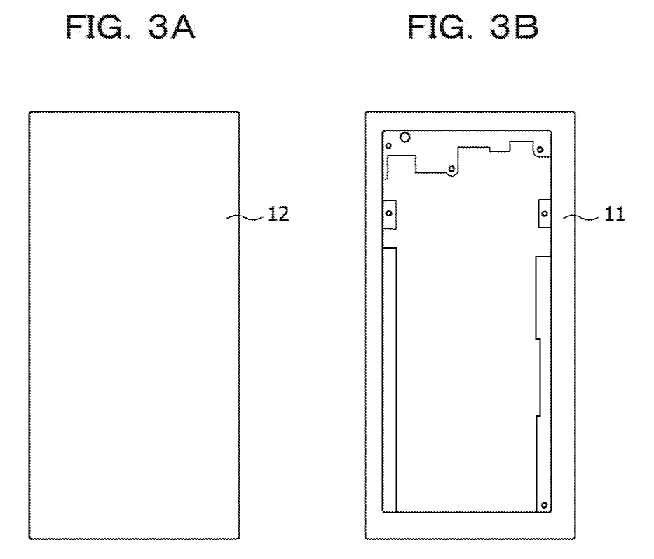

FIG. 1 depicts an example of a plan view of an electronic apparatus. FIG. 2 depicts an example of a sectional view taken along line I-I of FIG. 1. FIG. 3A depicts an example of a plan view of a display panel. FIG. 3B depicts an example of a plan view of a housing. The electronic apparatus may be a smartphone or may be an electronic apparatus other than a smartphone.

An electronic apparatus 10 depicted in FIGS. 1 and 2 includes a housing 11 formed from a plastic material, a metal material or the like, and a display panel 12. For example, in the housing 11, a wiring board on which a large number of electronic parts are mounted, a battery and so forth are accommodated. The display panel 12 is joined to the housing 11 by a bonding agent 15 and a double-sided adhesive tape 16. The display panel 12 includes a position detection mechanism provided thereon for detecting a position of the display panel 12 at which a user touches.

As depicted in FIGS. 1 and 2, the double-sided adhesive tape 16 is joined to a left upper corner portion of the housing 11. The bonding agent 15 is applied annularly along an edge of the housing 11 and is applied also to the double-sided adhesive tape 16. The width of the double-sided adhesive tape 16 is set greater than the width of the bonding agent 15.

For the bonding agent 15, for example, a urethane bonding agent, an acrylic bonding agent, an epoxy bonding agent or the like may be used.

The double-sided adhesive tape 16 includes a base and an adhesive adhered to the opposite faces of the base. For the base, for example, a polyethylene foamed resin, a polyethylene terephthalate (PET) film, an unwoven fabric or the like may be used. As the adhesive, an acrylic adhesive, a rubber type adhesive or the like may be used. The double-sided adhesive tape 16 may be an example of a joining member.

When the housing 11 and the display panel 12 are to be joined, the double-sided adhesive tape 16 is joined, for example, to a corner portion of the housing 11 as depicted in FIGS. 1 and 2. For example, the base of the double-sided adhesive tape 16 may be made of a polyethylene foamed resin, and the adhesive of the double-sided adhesive tape 16 may be an acrylic adhesive. The double-sided adhesive tape 16 may have a thickness of 0.3 mm and a width of 5 to 15 mm.

The bonding agent 15 is applied along an edge of the housing 11. The bonding agent 15 is applied also, for example, to the double-sided adhesive tape 16 as depicted in FIG. 1. Here, a urethane bonding agent may be used as the bonding agent 15. The bonding agent 15 may be applied, for example, to a width of 0.3 to 2 mm and a thickness of 0.4 mm.

The display panel 12 is placed on the housing 11, and pressure is applied such that the distance between the housing 11 and the display panel 12 may become, for example, 0.2 mm and the bonding agent 15 is hardened in this state. The electronic apparatus 10 depicted in FIGS. 1 and 2 is produced in this manner.

For example, as depicted in FIG. 1, the double-sided adhesive tape 16 is disposed only at part of an edge of the housing 11, and the housing 11 and the display panel 12 are joined together by the bonding agent 15 applied annularly along a edge of the housing 11. Although the region in which the double-sided adhesive tape 16 is disposed is low in joining strength in comparison with the other region in which only the bonding agent 15 is disposed, the region is a very small range in comparison with the whole. Therefore, the joining strength between the housing 11 and the display panel 12 may be secured sufficiently.

In the following, operation upon disassembly of the electronic apparatus 10 is described. In the disassembling operation of the electronic apparatus 10, the difference between the double-sided adhesive tape 16 and the bonding agent 15 in degree of decrease of the joining strength by heating is utilized.

The joining strength of both of the above-described bonding agent 15 and the double-sided adhesive tape 16 decreases by heating.

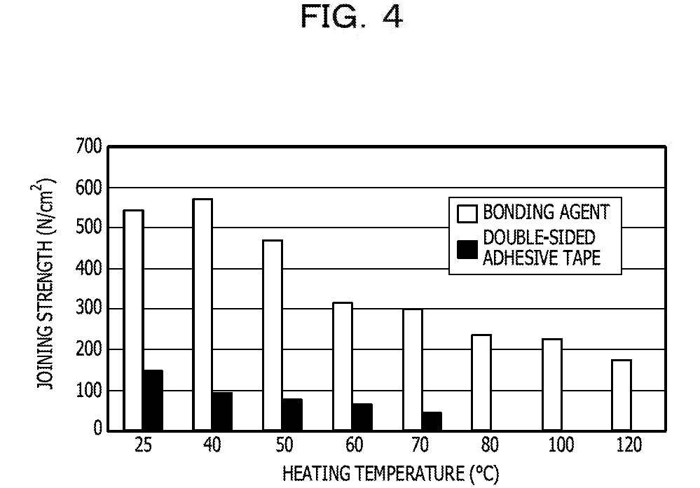

FIG. 4 illustrates an example of temperature dependence of joining strength of a bonding agent and a double-sided adhesive tape. In FIG. 4, the axis of abscissa indicates the heating temperature and the axis of ordinate indicates the joining strength, and a result of the temperature dependence of the joining strength of the bonding agent 15 and the double-sided adhesive tape 16 is indicated. As the bonding agent 15, a urethane bonding agent may be used. As the double-sided adhesive tape 16, a tape having an acrylic adhesive adhered to the surface of a base of a polyethylene formed resin may be used.

As illustrated in FIG. 4, if the heating temperature is equal to or higher than 50° C., the joining strength of both of the bonding agent 15 and the double-sided adhesive tape 16 decreases in comparison with that at room temperature (25° C.). In order to minimize degradation of a performance of the display panel 12, the heating temperature may be set to a temperature equal to or lower than 70° C. When the heating temperature is 70° C., the joining strength of the double-sided adhesive tape 16 indicates a sufficiently low value of 50 N/cm² or less.

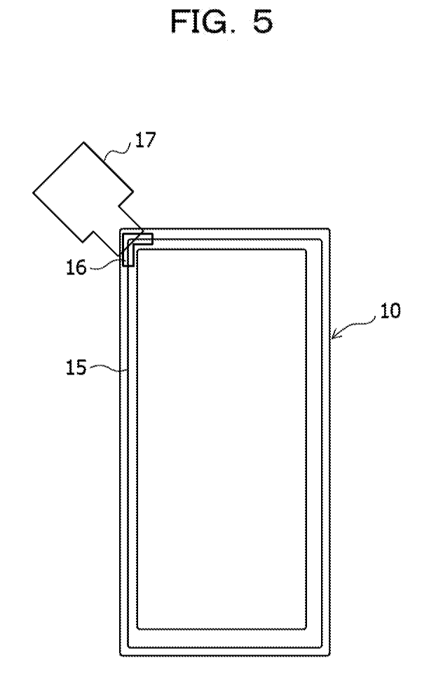

FIG. 5 illustrates an example of a disassembling method of an electronic apparatus. For example, after the electronic apparatus 10 is heated to 70° C., a distal end of a spatula (tool having a flattened distal end) 17 is inserted to a region of the double-sided adhesive tape 16 as depicted in FIG. 5. In this case, since the region of the double-sided adhesive tape 16 has a reduced joining strength, the distal end of the spatula 17 is inserted to the region of the double-sided adhesive tape 16 comparatively readily. The housing 11 and the display panel 12 are peeled in the region in which they are joined together by the bonding agent 15 with the region in which the spatula 17 is inserted as a start point of the peeling thereby to separate the housing 11 and the display panel 12 from each other.

Upon disassembly of the electronic apparatus 10 described above, the electronic apparatus 10 is heated. Since the joining strength of the double-sided adhesive tape 16 decreases by a larger amount by heating, the electronic apparatus 10 may be disassembled readily using a tool such as the spatula 17 without damaging the housing 11 or the display panel 12. The disassembled parts may be re-used effectively.

For example, although the double-sided adhesive tape 16 is disposed at only one of the four corner portions of the housing 11, the double-sided adhesive tape 16 may be disposed at two or more ones of the corner portions.

For example, although the double-sided adhesive tape 16 and the bonding agent 15 are adhered to the housing 11 side to join the housing 11 and the display panel 12 to each other, the double-sided adhesive tape 16 and the bonding agent 15 may be adhered to the display panel 12 side to join the housing 11 and the display panel 12 to each other.

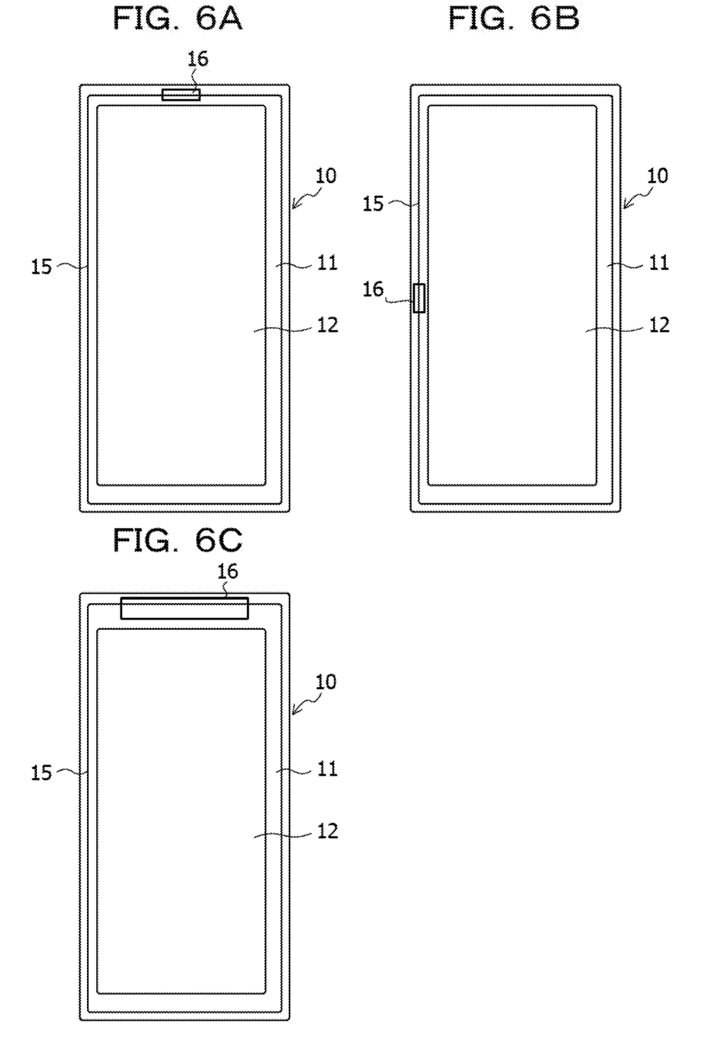

FIGS. 6A to 6C depict examples of a plan view of an electronic apparatus. The double-sided adhesive tape 16 may be disposed at a corner portion of the display panel 12 or may be disposed at a central portion of a short side of the display panel 12 as depicted in FIG. 6A. Alternatively, the double-sided adhesive tape 16 may be disposed at a central portion of a long side of the display panel 12 as depicted in FIG. 6B.

The region in which the double-sided adhesive tape 16 is disposed decreases in joining strength in comparison with the other region. Therefore, the double-sided adhesive tape 16 may be disposed in a region upon which stress is less likely to act and in which deflection is less likely to occur when the electronic apparatus 10 is used.

If the joining strength in ordinary use of the electronic apparatus 10 may be sufficiently secured, the double-sided adhesive tape 16 may be disposed over a comparatively wide range as depicted in FIG. 6C.

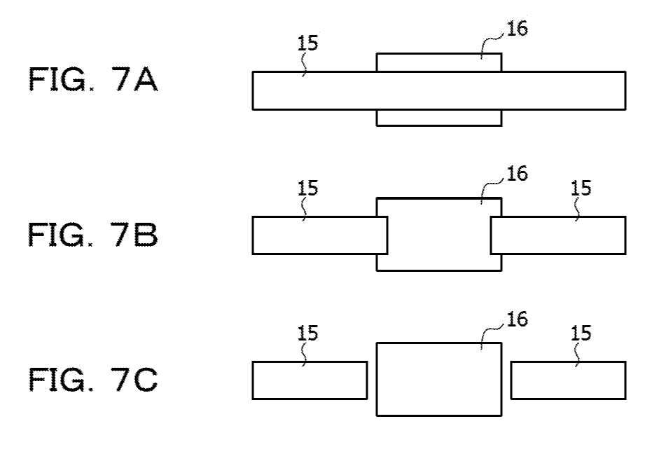

FIGS. 7A to 7C depict examples of a plan view of an electronic apparatus. As depicted in FIG. 7A, the bonding agent 15 may be applied to the double-sided adhesive tape 16. The bonding agent 15 may not be applied to a central portion of the double-sided adhesive tape 16 as depicted in FIG. 7B. Alternatively, some gap may be left between the double-sided adhesive tape 16 and the bonding agent 15 as depicted in FIG. 7C.

Where the waterproof property is taken into consideration, a bonding agent may be applied such that no gap is formed between the double-sided adhesive tape 16 and the bonding agent 15 as depicted in FIG. 7A or 7B.

The width of the double-sided adhesive tape 16 may be greater than the application width of the bonding agent 15 or may be substantially the same as the application width of the bonding agent 15 or else may be smaller than the application width of the bonding agent 15.

The double-sided adhesive tape 16 may be used, or a single-sided adhesive tape may be used in place of the double-sided adhesive tape 16. As the single-sided adhesive tape, a tape may be used which is formed, for example, from a PET film as a base and has an acrylic adhesive adhered to one face of the base.

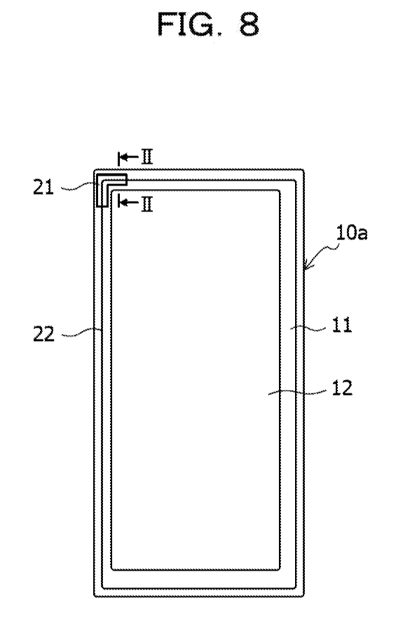

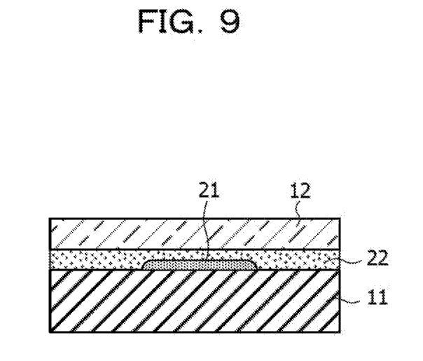

FIG. 8 depicts an example of a plan view of a different electronic apparatus, and FIG. 9 depicts an example of a sectional view taken along line II-II of FIG. 8.

Also an electronic apparatus 10a depicted in FIGS. 8 and 9 includes a housing 11 and a display panel 12 similarly as in FIGS. 1 and 2. As depicted in FIGS. 8 and 9, a second bonding agent 21 is applied to a left upper corner portion of the housing 11. A first bonding agent 22 is applied annularly along an edge of the housing 11 and is applied also to the second bonding agent 21. The application width of the second bonding agent 21 is set greater than the application width of the first bonding agent 22.

As the second bonding agent 21, a bonding agent may be used whose joining force decreases, when it is heated, for example, to 70° C., to such a degree that a distal end of a tool such as a spatula may be inserted to the joining region. As the second bonding agent 21, for example, a silicone bonding agent, a modified silicone bonding agent, a ultraviolet (UV) curable resin, a cyanoacrylate instant bonding agent or the like may be used. The second bonding agent 21 is an example of a joining member.

As the first bonding agent 22, a bonding agent may be used which has a higher bonding force than the second bonding agent 21 and may secure a sufficient joining strength in ordinary use of the electronic apparatus 10a. As the first bonding agent 22, a material same as that of the bonding agent 15 depicted in FIGS. 1 and 2, for example, a urethane bonding agent, an acrylic bonding agent, an epoxy bonding agent or the like may be used.

In the electronic apparatus 10a, the housing 11 and the display panel 12 are joined together by the first bonding agent 22 having a high joining strength and applied along an edge of the display panel 12. Therefore, similarly to the electronic apparatus 10 depicted in FIGS. 1 and 2, in ordinary use of the electronic apparatus 10a, a sufficient joining strength may be secured.

When the electronic apparatus 10a is to be disassembled, the electronic apparatus 10a is heated, for example, to a temperature of 70° C. to decrease the joining strength of the bonding agents 21 and 22. Thereafter, a distal end of a tool such as a spatula is inserted to the region of the second bonding agent 21. The housing 11 and the display panel 12 are separated from each other with the region into which the spatula is inserted as a start point.

Also the electronic apparatus 10a depicted in FIGS. 8 and 9 may be disassembled readily without damaging the housing 11 or the display panel 12.

Although the technology disclosed herein may be applied to an electronic apparatus that includes a housing and a display panel, the panel to be joined to the housing is not limited to a display panel.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A disassembling method for an electronic apparatus, comprising:
heating an electronic apparatus in which a housing and a panel are joined together by a first bonding agent disposed along an edge of the housing and a joining member disposed at part of the edge of the housing and having a joining strength lower than a joining strength of the first bonding agent;
inserting a distal end of a given tool to a region in which the joining member is disposed; and
separating the housing and the panel from each other with the region in which the tool is inserted as a start point.

2. The disassembling method according to claim 1, wherein the heating of the electronic apparatus is performed at a temperature equal to or lower than 70° C.

3. The disassembling method according to claim 1, wherein the joining member is a double-sided adhesive tape or a single-sided adhesive tape.

4. The disassembling method according to claim 1, wherein the joining member is a second bonding agent having a joining strength lower than the joining strength of the first bonding agent.

5. The disassembling method according to claim 1, wherein the joining member is disposed at a corner portion of the housing.

6. The disassembling method according to claim 1, wherein the joining member is disposed at part of a short side or at part of a long side of the housing.
